(19) United States
(12) Patent Application Publication
(10) Pub. No.: US 2008/0227658 A1
(43) Pub. Date: Sep. 18, 2008

(54) Cdna Microarrays With Random Spacers

(75) Inventors: Sven Bulow, Hamburg (DE); Heinz-Gerhard Kohn, Hamburg (DE); Jose Remacle, Malonne (BE)

Correspondence Address: KNOBBE MARTENS OLSON & BEAR LLP, 2040 MAIN STREET, FOURTEENTH FLOOR, IRVINE, CA, 92614, US

(73) Assignee: EPPENDORF AG, Hamburg (DE)

(21) Appl. No.: 11/908,009

(22) PCT Filed: Mar. 8, 2006
(86) PCT No.: PCT/EP06/02144

§ 371 Date: Mar. 13, 2008

(30) Foreign Application Priority Data
Mar. 11, 2005 (DE) 10 2005 011 350.8

(51) Int. Cl. C40B 40/06; C40B 50/18

(52) U.S. Cl. 506/16; 506/32

(57) ABSTRACT

The present invention discloses an improved cDNA microarray, which employs spacers of random sequence and a length of the spacers of at least 50 to 80 nucleotides. The inventive cDNA microarray may be employed for example in fields like the determination of gene expression, DNA sequencing, fingerprinting or mapping. In addition, a method for the preparation of the cDNA microarray, the use of spacer molecules with random sequence and a kit are specified.

### FIELD OF THE INVENTION

The present invention relates in general to the field of microarrays and in particular, to the improvement of cDNA microarrays by the use of random spacers of a length between at least 50 to 80 nucleotides. A cDNA microarray according to the present invention may be employed for example in fields like the determination of gene expression, DNA sequencing, fingerprinting or mapping. The present invention further specifies a method for the preparation of the cDNA microarray, the use of spacer molecules with random sequence and a kit.

### STATE OF THE ART

Nucleic acid sequences may be principally analyzed by the use of either gel electrophoresis of DNA fragment (e.g. of restriction fragments)—the so-called southern blot, hybridization events, and the direct sequencing of DNA (for example the Maxam-Gilbert method). All of the above-mentioned methods are widely spread in biological sciences, medicine and agriculture. The deficiencies of the three methods lie in that southern blots and hybridization experiments may be carried out fast, but are only useful for the analysis of short DNA strands. The DNA sequencing results in the accurate determination of the nucleic acid sequences, but is time consuming, expensive and connected with certain efforts when applied to greater projects, e.g. the sequencing of a complete genome. The microarray technology in contrast has already proved to combine some of the above advantages and is meanwhile a well established method if experiments have to be carried out cheap, reliable and at a high throughput.

The microarrays which are in some cases also referred to as hybridization arrays, gene arrays or gene chips comprise in brief a carrier or support on which at defined locations at a possibly high density capture molecules are attached directly or via a suitable spacer molecule. The spacer molecules may be considered to function as a “bridge” between the capture molecule and the surface of the carrier to allow an easier attachment of the capture molecule. Said capture molecules consist of relatively short nucleic acid sequences, in particular DNA, which is capable to hybridize specific to the target molecules or probe molecules to be analyzed resulting usually in DNA:DNA or DNA:RNA hybrids. The occurrence of the hybridization event is than detected with for example fluorescent dyes and analyzed.

The advantages of the microarray concept resides preliminary in its ability to carry out very large numbers of hybridization-based analyses simultaneously. Methods for the preparation of microarrays are exemplified in Maniatis et al., Molecular Cloning—A Laboratory Manual, First Edition, Cold Spring Harbor, 1982.

In particular, the hybridization event itself has been proven characteristic and crucial for the microarray technique, since the chosen hybridization conditions and the stringency of the reaction conditions have a great impact on the result. Out of this reason, several efforts have been undertaken to achieve an improved construction of the microarrays.

In this context, it is well known to the person skilled in the art that by the use of spacers a certain distance between the capture molecule and the surface of the carrier material may be created. This facilitates in turn the hybridization of the probes to the capture molecules, since they are more easily accessible and allow the hybridization over the complete length of the attached nucleic acid.

Chemical modifications of the carrier by the attachment of suitable spacers represent, thereby, one of the most important aspects of the production of microarrays and for the implementation in other for example biosensor and nanotechnology basing technologies. In spite of the fact of the development of numerous methods for the introduction of specific chemical or physical changes onto the solid surface of interest, there is continuous search for new synthetic approaches offering greater synthetic flexibility, allowing the building of new molecular structures to attach new molecules to the solid surfaces of interest and/or improving the number/yield of both spacers attached to the surface of the carrier and to the capture molecules.

Therefore, in several scientific areas various efforts have been undertaken, preliminary with the aim to achieve spacers with improved properties, which may be used in turn for the preparation of microarrays.

The WO 03070982 discloses the linkage of biomolecules in sets of two or more, with predefined three-dimensional orientation and spacing between said two or more biomolecules. Said linking method is used in the construction of novel, highly specific vehicles for the drug delivery, for example in gene therapy, and in the construction and performing of assays for the study of biomolecular interactions, for example receptor-ligand interaction studies.

The U.S. Pat. No. 6,818,376 relates to the acid degradation of the cross-linking unit of a photo resist polymer, which results in an improved pattern profile, enhanced adhesiveness, excellent resolution, sensitivity, durability and reproducibility.

In the U.S. Pat. No. 6,773,888 the use of photoactivatable silane compounds for the preparation of spacers is disclosed. The compounds have the general formula PG-LS-SN, wherein PG is a photoactivatable group, LS is a linkage and spacer group, and SN is a silane group. The silanes allow the photoactivatable silane compounds to be covalently bound to the surface of a substrate such as silica. A linkage and spacer joins the silane to the photoactivatable group. The photoactivatable group forms a hydrophobic layer that may be photochemically cross-linked with a layer of hydrophilic functional polymers.

The U.S. application Ser. No. 2005004356 specifies a linker nucleoside, its preparation and use for the covalent binding of biomolecules to oligonucleotides.

These improvements disclosed in the prior art allow preliminary the easier attachment of the spacer to the carrier and an improved binding. Such technologies and methods generally employ spacers of the identical sequence.

There is still a need in the improvement of the accessibility of probe molecules to the capture molecules. It is also desirable to advance the attachment of the capture molecules to the spacers in order to achieve a better and easier hybridization of the respective probe molecules thereon.

### OBJECT OF THE INVENTION

The present inventors found, that by providing the present microarray with spacers having a random sequence and a respective length from at least 50 to 80 monomers, wherein the spacers are attached by one of their respective ends to the surface of the carrier, the respective other end is more easily accessible to the capture molecule and allows an easier attachment of said spacer molecules during the preparation of the microarray.

Another advantage of microarray according to the present invention resides in that the random sequences of the spacer molecules account for an improved movement of the respective ends and the capture molecules attached thereto, which facilitates in turn the hybridization by the respective probe molecules. It is assumed that the overall length of a capture molecule is thereby more easily accessible to the respective (corresponding) probe molecule.

### DEFINITIONS

The term microarray as used herein refers to a carrier or support respectively, which is preferably solid and has a plurality of molecules bound to its surface at defined locations. The microarray is preferably composed of spacer molecules which are present at specifically localized areas on the surface of the carrier. Said spacer molecules are attached with their second end to respective capture molecules. In the above context a localized area is the area of the surface which contains capture molecules, attached by means of spacers to the surface of the carrier, and which capture molecules are specific for a determined target/probe molecule. The localized area is either known by the construction of the microarray or is defined during or after the detection and results in a specific pattern. A spot is the area where specific target molecules are fixed on their capture molecules and approved by a detector. As used herein, the tern carrier refers to any material that provides a solid or semi-solid structure and a surface for attaching any molecule(s). Such materials are preferably solid and include for example metal, glass, plastic, silicon, and ceramics as well as textured and porous materials. They also may include soft materials for example gels, rubbers, polymers, and other non-rigid materials. Preferred solid carriers are nylon membranes, epoxy-glass and borofluorate-glass. Solid carriers need not be flat and may include any type of shape including spherical shapes (e.g., beads or microspheres). Preferably solid carriers have a flat surface as for example in slides (such as object slides) and micro-titer plates, wherein a micro-titre plate is a dished container having at least two wells.

The terms bead, particle and microsphere refer to small solid carriers that are capable to move in a solution (i.e. that have dimensions smaller than those of the enclosure in which they reside). The beads may have a complete or partial spherical or cylindrical shape, even if they are not limited to any particular three-dimensional shape.

The expression attached describes a non-random chemical or physical interaction by which a connection between two molecules is obtained. The attachment may be obtained by means of a covalent bond. However, the attachments need not be covalent or permanent. Other kinds of attachment include for example the formation of metalorganic and ionic bonds, binding based on van der Waal's forces, or any kind of enzyme substrate interactions or the so called affinity binding. An attachment to the surface of a carrier or carrier may be also referred to as immobilization.

Spacers are molecules that are characterized in that they have a first end attached to the biological material and a second end attached to the solid carrier. Thus, the spacer molecule separates the solid carrier and the biological material, but is attached to both. The spacers may be synthesized directly or preferably attached as whole on the solid carrier at the specific locations, whereby masks may be used at each step of the processing. The synthesis comprises the addition of a new nucleotide on an elongating nucleic acid in order to obtain a desired sequence at a desired location by for example photolithographic technologies which are well known to the skilled person. Bindings within the spacer may include carbon-carbon single bonds, carbon-carbon double bonds, carbon-nitrogen single bonds, or carbon-oxygen single bonds.

The spacer has preferably at least 50 monomers in length and more preferable 50-80 monomers in length. Spacers suitable for use in the present invention include preferably nucleotides, which contain adenine, cytosine, guanine and thymine as bases and deoxyribose as the structural element. Furthermore, a nucleotide can, however, also comprise any artificial base known to current technology, which is capable of base pairing using at least one of the aforesaid bases (for example inosine). Further included in the term nucleotide are the derivatives of the previously mentioned compounds, in particular derivatives having dyes of fluorescent markers. The term random as used herein applies to the sequence of the spacer molecule, in that the succession of the respective nucleotides/monomers forming the spacer molecule is unknown prior sequencing of the respective spacer molecule.

The spacer may also consist of analogs of nucleic acids (for example the substitution of single nucleotides with artificial nucleotides like inosine). The spacer region consists preferably of a random sequence of bases. However, the spacer may also consist of a sequence of pseudo-random or non-random bases.

The spacer may be also designed to minimize template independent noise, which is the result of signal detection independent (in the absence) of the template.

The spacer further has suitable reactive groups, preferably at each end of for the attachment to the solid carrier, capture and probe molecule, respectively. Such reactive groups may comprise for example hydroxy-, thiol-, aldehyde-, amide- and thioamide-groups. In addition, the spacer may have side chains or other substitutions. The active group may be reacted by suitable means to form for example preferably a covalent bound between the spacer and solid carrier, capture or probe molecule. Suitable means comprise for example light. The reactive group may be optionally masked/protected initially by protecting groups. Among a wide variety of protecting groups, which are useful are for example FMOC, BOC, t-butyl esters, t-butyl ethers. The reactive group is used to build to attach specifically thereto (after the cleavage of the protecting group) another molecule. An polynucleotide or oligonucleotide is defined as a molecule comprising two or more deoxyribonucleotides, preferably at least 10 to 100 nucleotides, more preferably at least about 20 to 80 nucleotides and more preferably at least about 20 to 40. The exact size will depend on many factors, which in turn depend on the ultimate function or use of the oligonucleotide. The oligonucleotide may be produced in any way known to the skilled person, including chemical synthesis, DNA replication, reverse transcription, PCR, or a combination thereof

The terms complementary or complementarity are used in reference to polynucleotides (i.e., a sequence of nucleotides such as an oligonucleotide or a target nucleic acid) in the light of the base-pairing rules. Complementarity may be partial, in which only some bases of the nucleic acids are matched according to the base pairing rules. Alternatively, there may be a complete complementarity between the nucleic acids in such a way that there are no mismatches. The degree of complementarity between nucleic acid strands has significant effects on the stringency and strength of the hybridization between two different nucleic acid strands. This is of particular importance in microarrays as detection methods which depend upon binding between nucleic acids. Complementarity as used herein is not limited to the predominant natural base pairs. Rather, the term also encompasses alternative, modified and non-natural bases, including but not limited to those that pair with modified or alternative patterns of hydrogen. With regard to complementarity, it is important for some applications to determine whether the hybridization represents a complete or partial complementarity. If it is desired for example to detect the presence or absence of a particular DNA (such as from a virus, bacterium, fungi or protozoan), the only important condition is that the hybridization method ensures hybridization when the relevant sequence is present. Other applications in contrast, may require that the hybridization method distinguish between partial and complete complementarity, for example in the detection of genetic polymorphisms.

The term homology and homologous refers to a degree of identity. There may be partial homology or complete homology. A partially homologous sequence is one that is less than 100% identical to another sequence.

Hybridization is used in reference to the pairing of complementary nucleic acids. Hybridization and the strength of hybridization (i.e., the strength of the association between the nucleic acids) is influenced by such factors as the degree of complementarity between the nucleic acids, stringency of the conditions involved, and the melting temperature of the formed hybrid. Hybridization involves the annealing of one nucleic acid to another complementary nucleic acid, i.e., a nucleic acid having a complementary nucleotide sequence.

Stringency refers to the conditions, which are involved in a correct hybridization event, for example temperature, ionic strength, pH and the presence of other compounds, under which nucleic acid hybridizations are conducted. With high stringency conditions, nucleic acid base pairing will occur only between nucleic acid fragments that have a high frequency of complementary base sequences. Thus, conditions of weak or low stringency are often required when it is desired that nucleic acids that are not completely complementary to one another be hybridized or annealed together.

A marker or label refers to any atom or molecule that may be used to provide a detectable (preferably quantifiable) effect and that can be attached to a nucleic acid. Markers may include but colored dyes; radioactive labels; binding moieties such as biotin; haptens such as digoxgenin; luminogenic, phosphorescent or fluorogenic moieties; and fluorescent dyes alone or in combination with moieties that can suppress or shift emission spectra by the energy transfer of fluorescence. Markers may provide signals, which are detectable for example by fluorescence, radioactivity, colorimetry, gravimetry, X-ray diffraction or absorption, magnetism and enzymatic activity. A marker may be a charged moiety (positive or negative charge) or may also have a neutral charge. They may include or consist of nucleic acid or protein sequence. Preferred markers are fluorescent dyes.

A target or probe molecule refers to a nucleic acid molecule to be detected. Target nucleic acids may contain a sequence that has at least a partial complementarity with at least a probe oligonucleotide. The target nucleic acid may comprise single- or double-stranded DNA or RNA.

Probes or probe molecules refer to nucleic acids, which interact with/hybridize to a target nucleic acid to form a detection complex.

The term signal probe or probe relates to a probe molecule, which contains a detectable moiety, which are already outlined above.

As used herein, the term quencher refers to a molecule or material that suppresses or diminishes the detectable signal from a detectable moiety when the quencher is in the physical vicinity of the detectable moiety. For example, in some embodiments, quenchers are molecules that suppress the amount of detectable fluorescent signal from an oligonucleotide containing a fluorescent label when the quencher is physically near the fluorescent label. Quenching is referred to any process, which reduces the lifetime of the excited state of the fluorescent chromophore. Some of the processes, which account for a reduction of lifetime, are collisional and static quenching and energy transfer, whereas light scattering may appear as quenching (loss of fluorescent signal).

The expression sample is used in its broadest sense. On one side, it is meant to include a specimen or culture (for example microbiological cultures) and on the other, it is meant to include both biological and environmental samples. A sample may even include a specimen of synthetic origin. Biological samples may be animal, including human, fluid, solid or tissue, alternatively food and feed products and ingredients such as dairy items, vegetables, meat and meat by-products. Environmental samples include environmental material such as surface matter, soil, water, industrial samples and waste, as well as samples obtained from food and dairy processing instruments, apparatus, equipment, utensils, disposable and non-disposable items.

A polymerization agent refers to any agent capable of facilitating the addition of nucleoside triphosphates to an oligonucleotide. Preferred polymerization means comprise respective polymerases, capable to ligate nucleic acids. The term ligation refers to the formation of a phosphodiester bond between a 3′-OH and a 5′ P located at the termini of two strands of nucleic acid.

The term polyol means polyhydroxy alcohol. The polyols are organic molecules made of a carbon backbone and some oxygene groups being only alcohol groups and include for example mannitol and sorbitol.

As used herein, the term kit refers to any delivery system for delivering materials. In the context of reaction assays, such delivery systems include systems that allow for the storage, transport, or delivery of reaction reagents (e.g., oligonucleotides, enzymes, etc. in the appropriate containers) and/or supporting materials (e.g., buffers, written instructions for performing the assay etc.) from one location to another.

### DETAILED DESCRIPTION OF THE PRESENT INVENTION

According to a first embodiment of the present invention a cDNA rnicroarray is provided, which comprises a carrier or support. On the surface of said carrier spacer molecules of a random sequence, which are attached with their respective first ends at defined locations in form of a pattern. The pattern facilitates the subsequent analysis of the results in that each spot on the microarray may be easily assigned to a specific hybridization event. The spacer molecules have a length in the range from at least 50 to 80 nucleotides, which results in a higher flexibility of the respective second ends. As a result of both, the long spacer molecules and their random sequence, the interactions between the capture molecules to their adjacent ones are reduced. This decrease in steric hindrance in turn permits an easier hybridization of the probe molecules to the respective capture molecules.

The carrier of the cDNA microarray according to the present invention is preferably solid and consists of glass, metal or plastic. The surface of the solid carrier may be also chemically modified or treated to facilitate the attachment of the spacer molecules. Preferably also, at least 1 square centimeter of he surface of the carrier are accessible for the attachment of spacer molecules.

The microarray preferably has at least 100 spacer molecules attached per square centimeter of the solid carrier. This density may be, however, higher and be adapted to the respective application of the microarray. For example, the density of the nucleic acids attached per square centimeter of solid carrier amounts more preferably at least to 1.000, still more preferably at least to 5.000 and most preferably at least to 10.000 nucleotides per square centimeter.

The spacer molecules of the cDNA microarray of the present invention may be synthesized on the surface of the carrier monomer by monomer, employing for example a ligation reaction to couple the respective monomers and are preferably attached/immobilized by 20 means of particular reactive groups to the surface of the carrier. Said reactive groups are selected from hydroxy-, thiol-, aldehyde-, amide- and thioamide-groups, allowing an easy attachment.

In order to build up the cDNA microarray according to the present invention, the respective reactive groups are preferably protected by protecting groups comprising FMOC, BOC, t-butyl esters and t-butyl ethers. Said protecting groups may be cleaved from an end of the spacer molecule, to permit a specific attachment of said end to either the surface of the carrier or to a capture molecule.

The capture molecule of the cDNA microarray according to the present invention is preferably also attached to a marker molecule. Said marker molecule is preferably selected from a fluorescent marker and may be cleaved off prior the use of the present cDNA microarray. By the use of said markers a pre-normalization of the cDNA microarray may be performed to facilitate the analysis of the results. In this context the spacer and capture molecules used in the present invention are preferably selected in such a way that the effect of quenching is minimized as far as possible (for example by selecting the monomers forming the spacer and capture molecules in that they have no or a low fluorescence of their own). Some of the fluorescent markers, which are used in the present invention are cyanine dyes, preferably Cy3 and/or Cy5, renaissance dyes, preferably ROX and/or R110, and fluorescent dyes, preferably FAM and/or FITC.

The present invention provides in another preferred embodiment a method for the production of a cDNA microarray, employing random spacer molecules having a length in the range from at least 50 to 80 nucleotides. More precisely, the proposed method comprises the production of a cDNA microarray, wherein
either a first end of a spacer molecule or a single nucleotide (which is subsequently built up to a full-length spacer molecule) is attached by for example the usage of a polymerization agent to the surface of a carrier at a defined location thereof;
a capture molecule being in the spotting solution is added to the microarray, with a spotting volume normally being less than 1 microliter;
allowing the attachment of said capture molecule, which is present in the spotting solution, by for example the usage of a polymerization agent to the second end of the spacer molecule; and,
allowing the spotted solution to dry on the carrier.

The microarray thus obtained may be used for identification and/or quantification of DNA/RNA present in a sample, by attachment on capture molecules.

The spacer molecules and the capture molecules may be deposited by a droplet delivery system, piezzo or inkjet printing, micropipetting, nanopipetting. In a preferred embodiment, the deposit of the spacer molecules and the capture molecules is by contact printing system.

Additionally, a polyol may be added either to the spotting solution before the attachment of said capture molecule to the second end of said spacer molecule or directly afterwards to achieve a longer storage stability of the cDNA microarray at both ambient and cooling temperatures. The polyols may be any kind of polyols, which preferably dissolve very easily in spotting solutions with different aqueous buffers and which are compatible with the solubilization of the nucleotides. The polyols may be cyclic or may have a linear backbone and may contain atoms/groups other than hydroxy and hydrogen. The polyols may also be linked to other molecules by an alcohol function or by another function. The preferred polyols according to the invention are mannitol and sorbitol.

The carrier of the cDNA microarray according to the above mentioned embodiment is also preferably solid and consists of glass, metal or plastic, which may be chemically modified or treated to facilitate the attachment of the spacer molecules. Preferably, at least 1 square centimeter of he surface of the carrier are accessible for the attachment of spacer molecules. On said surface preferably at least 100 spacer molecules are attached per square centimeter. Also a higher density of the nucleic acids attached per square centimeter of solid carrier may be selected in dependence from the respective application of the microarray, and which amounts more preferably at least to 1.000, still more preferably at least to 5.000 and most preferably at least to 10.000 nucleotides per square centimeter. Also the spacer molecules of the above-mentioned embodiment are preferably immobilized by means of particular reactive groups to the surface of the carrier, which may be selected from hydroxy-, thiol-, aldehyde-, amide- and thioamide-groups and optionally be masked by protecting groups comprising FMOC, BOC, t-butyl esters and t-butyl ethers.

According to another embodiment of the present invention the use of spacer molecules with random sequences in a cDNA microarray is provided, wherein the length of said spacer molecules is in the range from at least 50 to 80 nucleotides.

The present invention provides also a kit for the preparation of spacer molecules with random sequences and a length from at least 50 to 80 nucleotides of each spacer molecule, which spacer molecules may be used for the preparation of the inventive cDNA microarray.

The advantages of the present cDNA microarray reside preliminary in the choice of the present spacer molecules having a random sequence and a length from at least 50 to 80 nucleotides. The present inventors found that the long spacer molecules of random sequence may interact between themselves (by hybridization). This effect nevertheless accounts surprisingly for better results in both, preparation of the microarray and the hybridization of the probe molecules. It may be assumed, that the respective ends of the spacer molecules (with or without capture molecules) do not form a regular surface, wherein each end of a particular spacer molecule has approximately the same distance to the other surrounding ones. The hybridization between spacer molecules leads rather to an irregular surface and therefore at some locations to a lower steric hindrance for the attachment of the probe molecules to the capture molecules. It is believed, that the hybridization between the spacer molecules occurs merely in a short portion of the spacer (for example 4 nucleic acids), which hybridization will be soon released once again, so that the ends of other spacer molecules are once again freely available. The chosen length of the spacer molecules of at least 50 to 80 nucleotides provides that the hybridization between the spacer molecules occurs over a short portion (in comparison to the length of the spacer molecules) and is released soon again (by e.g. the ambient temperature).

The cDNA microarray according to the present invention contains on its surface several discrete regions bearing the spacer molecules and attached thereto capture molecules capable to hybridize to a corresponding target nucleotide sequences (probe molecules) if the respective sequences exhibit a sufficient degree of complementarity. The hybridization of the capture molecules to the probe molecules, which may be present in the sample to be analyzed, results in a specific and characteristic pattern on the microarray. If the target sequence is suitably labeled, a signal may be detected, identified and measured directly at the hybridization location. The intensity of the respective signal allows the estimation of the amount of probe molecules, which are present in the sample. The probe molecule to be identified may be also labeled prior to the hybridization to the single stranded capture molecules. The labeling may be performed by incorporating labeled probe molecules or by attaching a label to the hybrids (amplicons) of the capture with the probe molecules.

To implement a typical cDNA microarray according to the preferred embodiments of the present invention, three components are required. First, the microarray or carrier respectively, second a reader unit and third any means for the evaluation of the results, e.g. a suitable computer software. The properties and characteristics of the microarray are already outlined above. The reader unit comprises in general a movable tray, focusing lens(es), mirrors and a suitable detector, e.g. a CCD camera. The moveable tray carries the microarray and may be moved to place the microarray within the light path of one or more suitable light sources, e.g. a laser with an appropriate wavelength to excite a fluorescent compound. The evaluation program or software may serve for example to recognize specific patterns on the array or to analyze different expression profiles of genes. In this case, the software searches colored points on the array and compares the intensity of different color spectra of the same point. The result may be interpreted by an analyzing unit and afterwards stored in a suitable file format for the further processing.

The probes, which are hybridized to the respective capture molecules, are generally covalently linked to two or more fluorescent dyes and the intensity of the fluorescence at different wavelengths of each point is compared to the background. The detector, e.g. a photomultiplier or CCD array, transforms low light intensities to an amplifiable electrical signal. Other methods use different enzymes, which are covalently bound to the nucleotide by means of a linker molecule. The enzymatic colorimetry uses for example alkaline phosphatase and horseradish peroxidase as marker. By contacting with a suitable molecule, a detectable dye may be achieved. Other chemoluminescent or fluorescent marker comprise proteins capable to emit a chemoluminescent or fluorescent signal, if irradiated with light of a discrete, specific wavelength, e.g. 488 nm for the green fluorescent protein. Radioactive markers are applied in case if low detection limits are required, but are due to their harmful properties not wide spread. Fluorescence marking is performed with nucleotides linked to a fluorescent chromophore. Combinations of nucleotides and fluorescent chromophore comprise in general Cy3 (cyanine 3)1 Cy5 (cyanine 5) labeled dUTP as dye, since they may be easily incorporated, the electron migration for fluorescence may be exited by means of customary lasers and they also have distinct emission spectra.

The hybridization in the microarray technology follows essentially the conventional conditions of southern or northern hybridizations, which are well known to the skilled person. The steps comprise a pre-hybridization, the intrinsic hybridization and a washing step after hybridization occurred. The conditions have to be chosen in such a way that background signals are kept low, minimal cross-hybridization (in general a reduced number of mismatches) occurs and with a sufficient signal strength, which has to be proportional for some applications to the concentration of the target molecule.

The hybridization event may be detected generally by two different kinds of array-scanners. One method employs the principle of the confocal laser microscopy, which uses at least one laser to scan the array in point-to-point manner. Fluorescence is than detected by photomultipliers, which amplify the emitted light. The cheaper GGD basing readers use typically filtered white light for the excitation. The surface of the array is scanned with this method in sections, which allows the faster achievement of results of a lower significance.

Of importance is also the so-called gridding for the analysis of the results, in which an idealized model of the layout of the microarray is compared with the scanned data to facilitate the spot definition. Pixels are classified (segmented) as spot (foreground) or background to produce the spotting mask. Segmentation techniques may be divided in fixed segmentation circle, adaptive circle segmentation, adaptive shape segmentation and histogram segmentation. The use of these techniques depends from the shape of the spots (regular, irregular) and the quality of the proximal arrangement of the spots.

Another important point for the evaluation of the results is the intensity of the distinct spots, since the concentration of hybridized nucleotides in one spot is proportional to the total fluorescence of this spot. In particular, the overall pixel intensity and the ratio of the different fluorescent chromophore used (in case of Cy3 and Cy5, green and red) are important for the calculation of the spot intensity. Beneath the spot intensity, also the background intensity has to be taken into account, since various effects may disturb the fluorescence of the spots, for example the fluorescence of the carrier and of the chemicals used for the hybridization. This may be performed by the so-called normalization, which includes the above-mentioned effects and others like fluctuations of the light source, the lower availability/incorporation of the distinct marker molecules (Cy5 worse than Cy3) and their differences in emission intensities. Of importance for the normalization is further the reference against which shall be normalized. In general, this may be a specific set of genes or a group of control molecules present on the microarray. The results may be analyzed by either free available or purchased available software tools.

1. A cDNA microarray, which comprises a carrier and attached on the surface of said carrier at defined locations thereof first ends of spacer molecules, which spacer molecules have second ends attached to capture molecules, wherein the spacer molecules have random sequences and the length of said spacer molecules in at least 50 to 80 nucleotides.

2. The cDNA microarray according to claim 1 wherein said carrier is solid and consists of glass, metal or plastic.

3. The cDNA microarray according to claim 1, wherein said surface of said carrier comprises an area of at least 1 square centimeter.

4. The cDNA microarray according to claim 1, wherein said spacer molecules are attached to the surface of said carrier with a density of at least 100 spacer molecules per square centimeter.

5. The cDNA microarray according to claim 1, wherein said first and second ends comprise reactive groups selected from hydroxy-, thiol-, aldehyde-, amide- and thioamide-groups.

6. The cDNA microarray according to claim 5, wherein said reactive groups of said first and second ends are protected by a protecting group selected from the group consisting of FMOC, BOC, t-butyl esters and t-butyl ethers.

7. The cDNA microarray according to claim 1, wherein said capture molecule is attached to a marker molecule.

8. The cDNA microarray according to claim 7, wherein said marker molecule is selected from the group consisting of cyanine dyes, renaissance dyes, and fluorescent dyes.

9. A method for the production a cDNA microarray, said method comprising:
a) allowing the attachment of a first end of a spacer molecule on a surface of a carrier at a defined location thereof,
b) optionally allowing the attachment of a single nucleotide on the surface of said carrier at a defined location thereof and constructing therefrom the spacer molecule;
c) depositing the spotting solution on the surface of said carrier;
d) allowing the attachment of a capture molecule to a second end of said spacer molecule; and
e) allowing the spotted solution to dry on the carrier; wherein the spacer molecules have random sequences and the length of said spacer molecules is at least 50 to 80 nucleotides.

10. The method according to claim 9, wherein a polyol has been added either to the spotting solution before the attachment of said capture molecule to the second end of said spacer molecule or directly afterwards.

11. The method according to claim 9, wherein said carrier is solid and consists of glass, metal or plastic.

12. The method according to claim 9, wherein said surface of said carrier comprises an area of at least 1 square centimeter.

13. The method according to claim 9, wherein said spacer molecules are attached to the surface of said carrier with a density of at least 100 spacer molecules per square centimeter.

14. The method according to claim 9, wherein said first and second ends comprise reactive groups selected from hydroxy-, thiol-, aldehyde-, amide- and thioamide-groups.

15. The method according to claim 9, wherein said reactive groups of said first and second ends are protected by a protecting group selected from the group consisting of comprising FMOC, BOC, t-butyl esters and t-butyl ethers.

16. (canceled)

17. Kit for the preparation of spacer molecules with random sequences and a length from at least 50 to 80 nucleotides of each spacer molecule.

18. The cDNA microarray according to claim 8, wherein said cyanine dyes are Cy3 and/or Cy5, said renaissance dyes are ROX and/or R110, and said fluorescent dyes are FAM and/or FITC.
